(19) United States
(12) Patent Application Publication
(10) Pub. No.: US 2026/0050495 A1
(43) Pub. Date: Feb. 19, 2026

(54) GENERATING APPLICATION PROGRAMMING INTERFACE (API) CALLS USING GENERATIVE ARTIFICIAL INTELLIGENCE MODELS

(71) Applicant: QUALCOMM Incorporated, San Diego, CA (US)

(72) Inventors: Amr Mamoun MARTINI, San Diego, CA (US); Arvind Vardarajan SANTHANAM, San Diego, CA (US)

(21) Appl. No.: 18/804,629

(22) Filed: Aug. 14, 2024

(51) Int. Cl. G06F 9/54

(52) U.S. Cl. CPC G06F 9/541

(57) ABSTRACT

Certain aspects provide techniques and apparatus for invoking functions in a computing system using machine learning models. An example method generally includes receiving a request to execute an action in the computing system. Using a machine learning model, a plurality of application programming interface (API) call samples are generated for the received request. Based at least on keys in the plurality of API call samples and corresponding keys in API calls in a repository of API calls, a candidate API call for the received request is identified. A function associated with the candidate API call is invoked in response to the request.

### INTRODUCTION

Aspects of the present disclosure relate to application programing interface call generation.

Generative artificial intelligence models, such as large language models, can be used in artificial intelligence assistants to allow users of such assistants to interact using natural language inputs (e.g., spoken prompts converted from audio to text, textual prompt inputs, etc.). Generally, these artificial intelligence assistants can be used to perform various tasks through different plugins or other tools which interface with these artificial intelligence assistants. These plugins may, for example, allow users to obtain news from various sources (e.g., weather sources, news outlets, equities market data feeds, etc.), schedule events, plan travel, control robots or other household devices, or the like.

### BRIEF SUMMARY

Certain aspects provide a processor-implemented method for invoking functions in a computing system using machine learning models. An example method generally includes receiving a request to execute an action in the computing system. Using a machine learning model, a plurality of application programming interface (API) call samples are generated for the received request. Based at least on keys in the plurality of API call samples and corresponding keys in API calls in a repository of API calls, a candidate API call for the received request is identified. A function associated with the candidate API call is invoked in response to the request.

Other aspects provide processing systems configured to perform the aforementioned methods as well as those described herein; non-transitory, computer-readable media comprising instructions that, when executed by one or more processors of a processing system, cause the processing system to perform the aforementioned methods as well as those described herein; a computer program product embodied on a computer-readable storage medium comprising code for performing the aforementioned methods as well as those further described herein; and a processing system comprising means for performing the aforementioned methods as well as those further described herein.

The following description and the related drawings set forth in detail certain illustrative features of one or more aspects.

### BRIEF DESCRIPTION OF THE DRAWINGS

The appended figures depict example features of certain aspects of the present disclosure and are therefore not to be considered limiting of the scope of this disclosure.

FIG. 1 illustrates an example pipeline for generating API calls using a generative artificial intelligence model, according to aspects of the present disclosure.

FIG. 2 illustrates an example pipeline for API call sample aggregation, according to aspects of the present disclosure.

FIG. 3 illustrates an example of API call searching based on embeddings associated with generated API call samples, according to aspects of the present disclosure.

FIG. 4 illustrates an example of API call matching based on key embeddings, according to aspects of the present disclosure.

FIG. 5 illustrates an example of API call matching based on value embeddings, according to aspects of the present disclosure.

FIG. 6 illustrates example operations for invoking functions in a computing system using machine learning models, according to aspects of the present disclosure.

FIG. 7 depicts an example processing system configured to perform various aspects of the present disclosure.

To facilitate understanding, identical reference numerals have been used, where possible, to designate identical elements that are common to the drawings. It is contemplated that elements and features of one aspect may be beneficially incorporated in other aspects without further recitation.

### DETAILED DESCRIPTION

Aspects of the present disclosure provide apparatuses, methods, processing systems, and non-transitory computer-readable mediums for invoking functions in a computing system using generative artificial intelligence models.

Artificial intelligence model-based assistants generally allow users to interact with a computing device using natural language inputs in order to execute various tasks on or using the computing device. To do so, an artificial intelligence model-based assistant can interface with various software tools that can ingest specific types of information in order to perform specific tasks. For example, an artificial intelligence model-based assistant can interface with a first application to respond to requests to add events to a calendar, a second application to respond to requests for the latest news, a third application to respond to requests to book flights or hotel rooms, and the like. These applications generally may be invoked through calling functions exposed by various application programming interfaces (APIs).

Because artificial intelligence model-based assistants can potentially interface with many APIs, each of which may have distinct calling conventions, key (variable) names, valid value ranges, and the like, determining which API and which function in an API to invoke is a challenging task, especially as the number of applications which can be used to perform various tasks through an artificial intelligence model-based assistant increases. For example, in order to determine which API is relevant to a task, an artificial intelligence model-based assistant may first attempt to match a user intent (e.g., a task which the user wishes to execute given a natural language input into the assistant) to an application (and corresponding API), and then may attempt to identify the function exposed by the API that should be invoked in order to execute a task matching the user intent. However, because the artificial intelligence models that power these assistants generate natural language outputs, these natural language outputs generally do not match the format of an API call that causes an application to execute a function. Further, as new applications are developed, the artificial intelligence models that power these assistants may not be able to generate the appropriate API calls for invoking specified functions using these new applications.

To allow artificial intelligence model-based assistants to interface with various applications, generative artificial intelligence models may be trained to represent API calls in an embedding space and match an embedding associated with a user input (e.g., query, natural language input, etc.) to embedding representations of API calls. A set of K API calls having embedding representations that are similar to the embedding representation of the user input may be inserted as contextual data into a generative artificial intelligence model for the generative artificial intelligence model to use in generating API call samples, which may subsequently be validated using ground-truth knowledge of the calling conventions, key names, and valid value ranges for different APIs. If an API call generated by the generative artificial intelligence model is validated against this ground-truth knowledge, the API call may be passed back to the assistant for the assistant to call; otherwise, an error may be returned.

While these generative artificial intelligence models can generate API calls that allow an assistant to respond to various user inputs, the complexity involved with interfacing with a variety of applications generally imposes restrictions on the ability of these generative artificial intelligence models to accurately generate API calls that are responsive to a user input. For example, because of the size of API documentation defining the calling conventions, key names, and valid value ranges for different keys, prior dialog relevant to satisfying a user input may be truncated, which may degrade the ability of an artificial intelligence model-based assistant to respond to user queries. Further, while multiple APIs may be relevant to a user input, the generative artificial intelligence model may not be able to pre-compute data usable during the inferencing process for multiple candidate APIs because data for different APIs may not be spliced together during the inferencing process and because it may not be practical to precompute data for all possible combinations of APIs. Moreover, there may be a mismatch between API documentation and user inputs, which may result in the generation of invalid API calls or an inability to identify an appropriate API call responsive to a user input.

Aspects of the present disclosure provide techniques for invoking functions in a computing system using machine learning models. As discussed in further detail herein, a machine learning model may be trained to generate sample API calls that are unbound from the calling conventions, key names, and valid value ranges of any specific API. An API call refinement process may be used to aggregate calls into a set of API calls which can be compared to known API calls. Based on this comparison, a relevant API call may be identified and output to an assistant or other application which can then invoke the identified API call to call a function that is responsive to a user input (e.g., a user query). By doing so, aspects of the present disclosure may allow for generative artificial intelligence models used in processing user queries to accurately and efficiently identify API functions to call to satisfy user inputs. Further, because the generative artificial intelligence model is trained to generate sample API calls that are unbound from actual API calls and use matching techniques to identify the API call to be invoked across a variety of APIs, certain aspects of the present disclosure allow the generative artificial intelligence model to identify and invoke API calls from a variety of APIs without training the model on the specific details of any single API. Thus, the generative artificial intelligence model can generate API calls for APIs added to a system without retraining the model, which may allow for rapid adaptation of a generative artificial intelligence model to new APIs and minimize, or at least reduce, computing resource utilization for acquiring and generating training data for training generative artificial intelligence models, as well as training and retraining the generative artificial intelligence model. Example Application Programming Interface (API) Call Identification Using Generative Artificial Intelligence Models

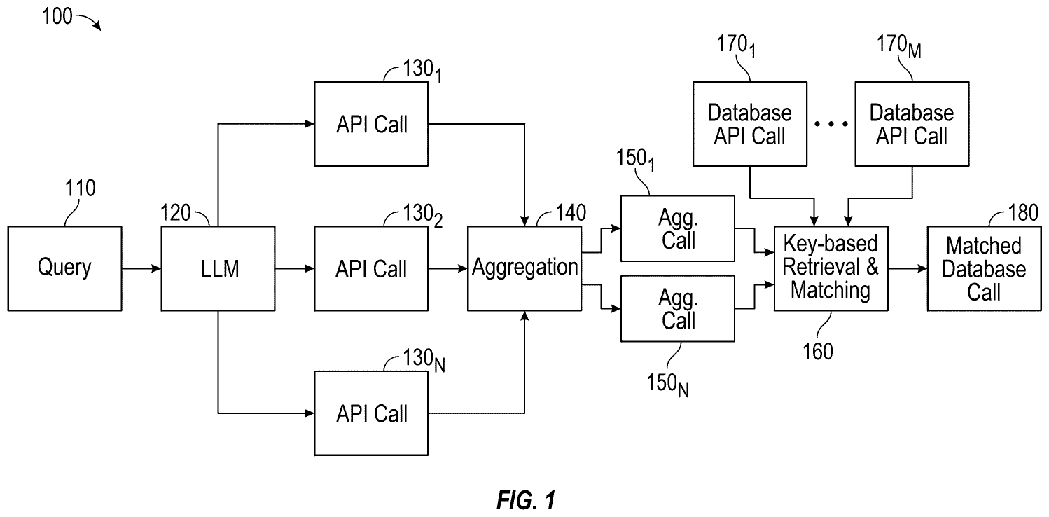

FIG. 1 illustrates an example pipeline 100 for generating API calls using a generative artificial intelligence model, according to aspects of the present disclosure.

As illustrated, the pipeline 100 generally generates an API call in response to an input query 110. The input query 110 may be, for example, a natural language string input provided to an assistant that uses the pipeline 100 to identify an API call to use to satisfy an intent of the input query 110, an audio recording of a natural language utterance, or the like. The input query 110 (or a string representation thereof) may be input into a generative artificial intelligence model 120, which may be a large language model (LLM) or other generative artificial intelligence model that is capable of generating a textual response to an input query, for processing. Generally, the generative artificial intelligence model may be a model trained to generate sample API calls, such as the API calls 130₁-130_{N} (collectively referred to as “API calls 130”) that are responsive to the input query 110 (or an intent derived therefrom).

Generally, the sample API calls may include a function name, any number of keys associated with variables provided as arguments into the function, and values associated with these keys. These sample API calls, while responsive to the input query 110 or intent derived therefrom, may not be valid API calls for any particular application with which an assistant interfaces. However, as discussed in further detail below, the keys and values associated with these API calls can be used to identify a valid API call that is responsive to the input query 110.

After the API calls 130 are generated by the generative artificial intelligence model 120, the API calls 130 may be aggregated at block 140 into a plurality of aggregated calls 150₁-150_{N} (collectively referred to as “aggregated calls 150”). Generally, aggregating the API calls 130 may reduce the number of API calls for processing by consolidating API calls 130 that are semantically similar to each other. The API calls 130 may be consolidated into the aggregated calls 150 based on key-value pair embeddings associated with the API calls, and a graph may be constructed based on the key-value pair embeddings with different nodes corresponding to different key-value pair embeddings and related key-value pairs (e.g., key-value pairs with embeddings that are similar) being connected by edges between the associated nodes. Based on the generated graph, a plurality of cliques may be identified, with each clique representing different combinations of related key-value pairs. The aggregated calls 150 may subsequently be generated based on the cliques identified in the graph.

The aggregated calls 150 may subsequently be processed at the call matching block 160 to identify a matching real-world API call 180 from real API calls 1701-170M (collectively referred to as “real API calls 170”). As discussed in further detail below, to identify a matching real-world API call 180 for the input query 110, keys, and in some aspects, values, may be matched between the aggregated calls 150 and the real API calls 170 to identify a matching API call. The matching may be performed based on comparisons of embeddings associated with the keys and/or values in the aggregated calls 150 with the keys and/or values in the real API calls 170. A matching score for each pair of an aggregated call 150 and a real API call 170 may be generated based on a similarity metric calculated between key embeddings and/or value embeddings in the aggregated calls 150 and corresponding key embeddings and/or value embeddings in the real API calls 170. The real API call 170 in a pair having the highest matching score may be selected as the matching real-world API call 180, and the matching real-world API call 180 may be output to the assistant or other application for use in satisfying the intent expressed by the input query 110.

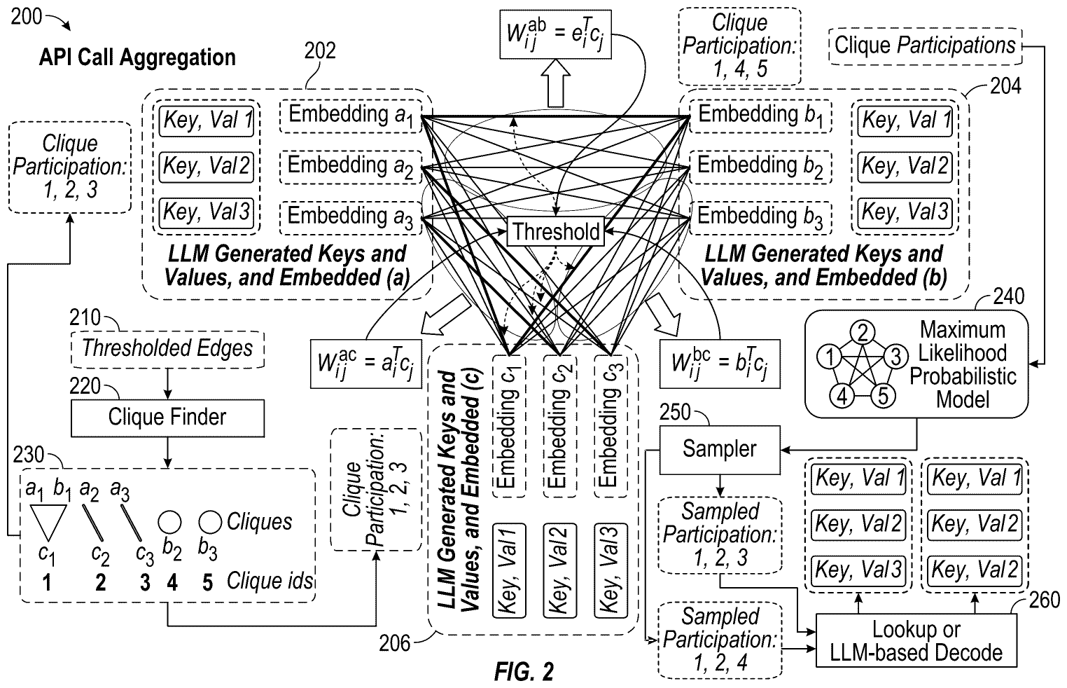

FIG. 2 illustrates an example pipeline 200 for API call sample aggregation, according to aspects of the present disclosure.

To aggregate generated API calls 202, 204, 206 (which may correspond to the API calls 130 illustrated in FIG. 1) into a plurality of aggregated calls 150, the keys and values associated with each of the generated API calls 202, 204, and 206 may be converted into embeddings a₁-aₙ, b₁-bₙ, and c₁-cₙ, respectively, using an embedding model. Generally, these embeddings may represent the keys and values in each of the generated API calls 202, 204, 206 as values in a latent space which can be used to identify cliques of related API calls.

To identify cliques of related generated API calls, a similarity score may be calculated between the embeddings for each of the generated API calls 202, 204, and 206 (amongst others, not illustrated in FIG. 2). A similarity score between any two generated API calls may be represented as a dot product between the embeddings associated with the keys and values in each API call. For example, a similarity score between the embedding of the i^{th} key-value pair in the generated API call 202 and the embedding of the j^{th} key-value pair in the generated API call 204 may be calculated according to the equation:

$${W}_{ij}^{ab} = {a}_{i}^{T} {b}_{j}$$

In the equation above,

$${a}_{i}^{T}$$

represents a transform performed on the embedding aᵢ representing the i^{th} key-value pair. As illustrated in FIG. 2, similarity scores may be calculated for each pair of key-value pair embeddings for use in aggregating the generated API calls into a plurality of aggregated API calls. For example, similarity scores between embeddings associated with the generated API call 204 having embeddings b₁, . . . bₙ and the generated API call 206 having embeddings c₁, . . . , cₙ may be represented by the equation

$${W}_{ij}^{ab} = {b}_{i}^{T} {c}_{j}$$

for the embedding bᵢ of the i^{th} key-value pair in the generated API call 204 and the embedding c₁ of the j^{th} key-value pair in the generated API call 206; similarity scores between embeddings associated with the generated API call 202 having embeddings a₁, . . . , aₙ and the generated API call 206 having embeddings c₁, . . . , cₙ may be represented by the equation

$${W}_{ij}^{ac} = {a}_{i}^{T} {c}_{j} .$$

To generate the plurality of cliques 230 of key-value pair embeddings, a graph representation of the key-value pair embeddings may be generated by the clique finder 220. In doing so, the graph representation may be generated based on thresholding similarity scores at a thresholding block 210 between different pairs of key-value embeddings to identify connections between pairs of key-value embeddings that are likely the same or similar. Generally, the graph representation may be initially generated by generating edges between different pairs of key-value embeddings, and a weight (or similarity score) may be calculated for each key-value pair. Using a threshold score, edges between different key-value pairs may be maintained (if above the threshold score) or dropped (if below the threshold score). Based on the reduced graph representation of the universe of key-value embeddings, a plurality of cliques 230 may be generated by a clique finder 220. In some aspects, the cliques may be generated using a clique finding technique that results in the generation of a plurality of cliques representing different generalized key-value pairs. Generally, similarity scores for embeddings in different generated API call samples may be thresholded at a thresholding block 210 to identify connections between pairs of key-value embeddings that are likely the same or similar. Based on the cliques 230, defined as sets of nodes in the reduced graph representation of the generated API calls 202, 204, 206 (and others not illustrated in FIG. 2) where every node in the set is connected with every other node in the set, a local probabilistic model 240 that models the probability of observing specific observations of cliques may be used to identify combinations of cliques based on a maximization, or at least an increase, in the likelihood associated with an observed clique combination identified by the clique finder 220. Generally, the maximization techniques used to identify the combination of cliques allows for the identification of cliques, corresponding to specific API calls or key-value pairs associated with API calls, that are likely to go with each other. By doing so, outlier cliques, or cliques representing specific API calls or call parameters that are not likely to go with others in a combination of cliques, may be filtered out.

In some aspects, the cliques identified by the local probabilistic model 240 may be sampled at a sampling block 250 to identify participating key-value pairs that are likely to refer to the same, or at least semantically similar, concepts. The sampled, participating key-value pairs may be decoded into textual key-value pairs based on a reverse lookup of embeddings to key-value pairs and output as part of the aggregated API calls 130 illustrated in FIG. 1.

In some aspects, to identify cliques of key-value pair embeddings, the embeddings for the generated API calls 202, 204, 206 may be aggregated into a graph representation. Each embedding, representing a specific key-value pair, may be a node in the graph representation, while the similarity scores generated for each pair of key-value pair embeddings may be used as a weight of an edge between nodes in the graph representing a specific embedding. Unique sets of edges within the graph representation may be defined such that edges connect semantically similar key-value pairs but do not connect semantically different key-value pairs. Generally, a semantically similar key-value pair may be a key-value pair connected by an edge in the graph and having a weight above a threshold weight. Meanwhile, semantically different key-value pairs may not be represented by connections in the graph representation.

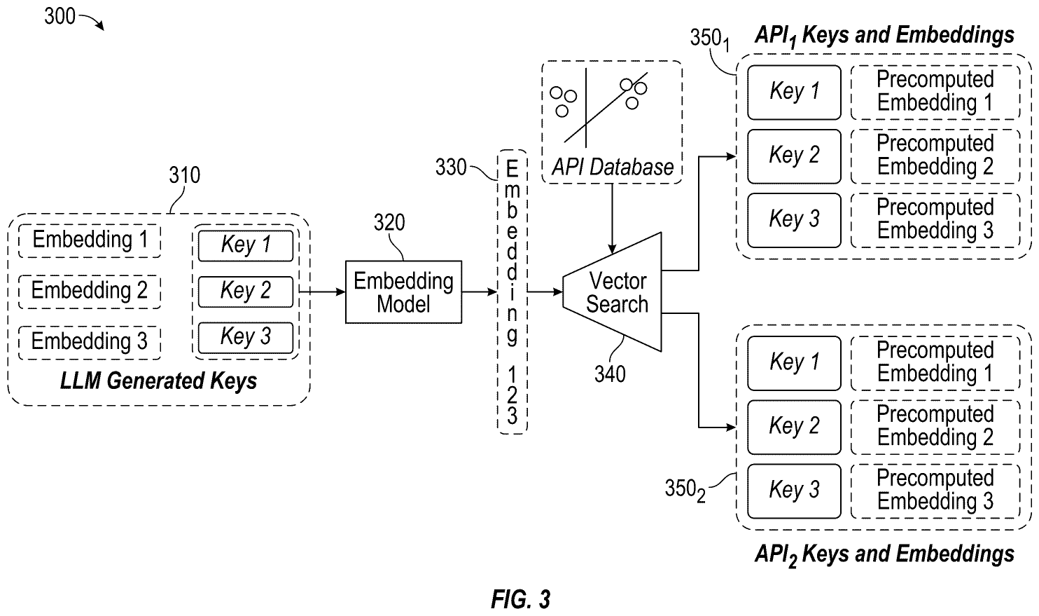

FIG. 3 illustrates an example 300 of API call searching based on embeddings associated with generated API call samples, according to aspects of the present disclosure.

As illustrated, to search for matching real API calls (e.g., the real API calls 170 illustrated in FIG. 1), a key-based comparison between an aggregated API call 310 (corresponding to one of the aggregated API calls 150 illustrated in FIG. 1). An aggregated API call, including a plurality of keys and embeddings associated therewith, may be embedded into a sequence embedding 330 using an embedding model 320. The sequence embedding may be a latent space representation of a sequence of API keys included in the aggregated API call 310.

To identify candidate API calls that can be executed to satisfy an intent of a user input into an assistant or other application, a vector search 340 may be performed against precomputed embeddings associated with real API calls to identify matching real API calls 350₁, 350₂ (amongst others, not illustrated in FIG. 3, and referred to collectively as “matching real API calls 350”) that are semantically similar to the aggregated API call 310. In some aspects, the vector search 340 may allow for the calculation of a distance between the sequence embedding 330 of the aggregated API call 310 and precomputed embeddings of real API calls in one or more databases defining the format of API calls for various plugins or other applications with which an assistant can interface in order to satisfy a user input. In some aspects, the matching real API calls 350 may be determined based on a k-nearest neighbor technique in which the k real API calls having the closest distance between precomputed embeddings and the sequence embedding 330 of the aggregated API call 310 are selected as the matching real API calls 350. In some aspects, the vector search 340 may identify the matching real API calls 350 as the API calls with distances between the corresponding precomputed embeddings and the sequence embedding 330 of the aggregated API call 310 below a threshold distance.

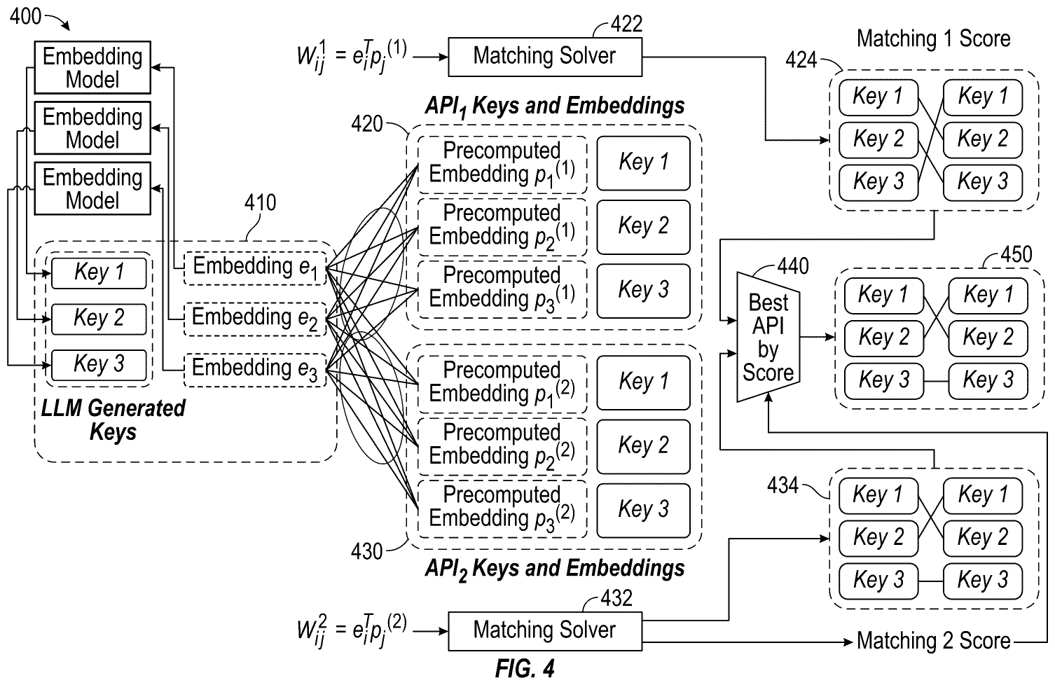

FIG. 4 illustrates an example 400 of key-based matching to identify an API call to use in satisfying a user query based on key embeddings, according to aspects of the present disclosure.

After a plurality of matching API calls are identified based on the search illustrated in FIG. 3, key-based matching between an aggregated API call 410 (corresponding to one of the aggregated API calls 150 illustrated in FIG. 1) and the matching real API calls 420 and 430 (corresponding to the matching real API calls 350 illustrated in FIG. 3) may be performed. To do so, embeddings of keys in the aggregated API call 410 may be generated for a comparison with precomputed embeddings of keys associated with the matching real API calls 420 and 430 (amongst others, not illustrated in FIG. 4). A matching solver 422 may be used to determine matching scores used to map keys in the aggregated API call 410 to keys in the matching real API call 420 in a mapping 424. Similarly, a matching solver 432 may be used to determine matching scores used to map keys in the aggregated API call 410 to keys in the matching real API call 430 in a mapping 434.

As illustrated, the aggregated API call 410 includes a plurality of keys represented by embeddings e₁ through e₃, the matching real API call 420 includes a plurality of keys represented by embedding

$${p}_{1}^{( 1 )}$$

through

$${p}_{3}^{( 1 )} ,$$

and the matching real API call 430 includes a plurality of keys represented by embedding

$${p}_{1}^{( 2 )}$$

through

$${p}_{3}^{( 2 )} .$$

A matching score may be calculated on a pairwise basis between embeddings of keys associated with the aggregated API call 410 and precomputed embeddings of keys associated with the matching real API calls 420 and 430 (amongst others, not illustrated in FIG. 4). To do so, a distance (or similarity) W between the embeddings may be calculated based on a dot product of embeddings e in the aggregated API call 410 and embeddings p associated with one of the matching real API calls 420, 430. As illustrated, the distance between the embedding of the i^{th} key in the aggregated API call 410 and the embedding of the j^{th} key in a matching real API call (e.g., 420 or 430) may be calculated according to the equation:

$${W}_{ij} = {e}_{i}^{T} {p}_{j}$$

where

$${e}_{i}^{T}$$

represents a transform of the embedding eᵢ and pⱼ represents the precomputed embedding of the j^{th} key in the matching real API call.

Based on the pairwise matching scores, a mapping between keys may be generated. To identify the mappings 424, 434, the respective matching solver 422, 432 can construct a graph for pairings between the aggregated API call and one of the matching real API calls 420, 430 (amongst others). The graph may be established such that nodes in the graphs represent keys and edges connect keys in the aggregated API call 410 and keys in a matching real API call (e.g., one of the matching real API calls 420, 430). The weights of an edge connecting the i^{th} key from the aggregated API call 410 and the j^{th} key from a matching real API call generally correspond to the calculated distance (or similarity score) between the embeddings of the i^{th} key from the aggregated API call 410 and the j^{th} key from a matching real API call.

Based on the graph, a maximum matching solution may be identified using various techniques. For example, the Hungarian matching technique or other constrained optimization algorithms that can be used to solve an assignment or matching problem may be used to identify the mappings 424, 434. The mappings 424, 434 may be processed by an API scoring block 440 to identify the mapping 424, 434 with the highest matching score. The matching score for a mapping 424, 434 may, for example, be the sum of the weights of edges between keys from the aggregated API call 410 and keys from the matching real API call for which the mappings 424, 434 are calculated. As illustrated, in this example, the selected API call 450 selected by the API scoring block 440 may correspond to the mappings 434 between the aggregated API call 410 and the matching real API call 430.

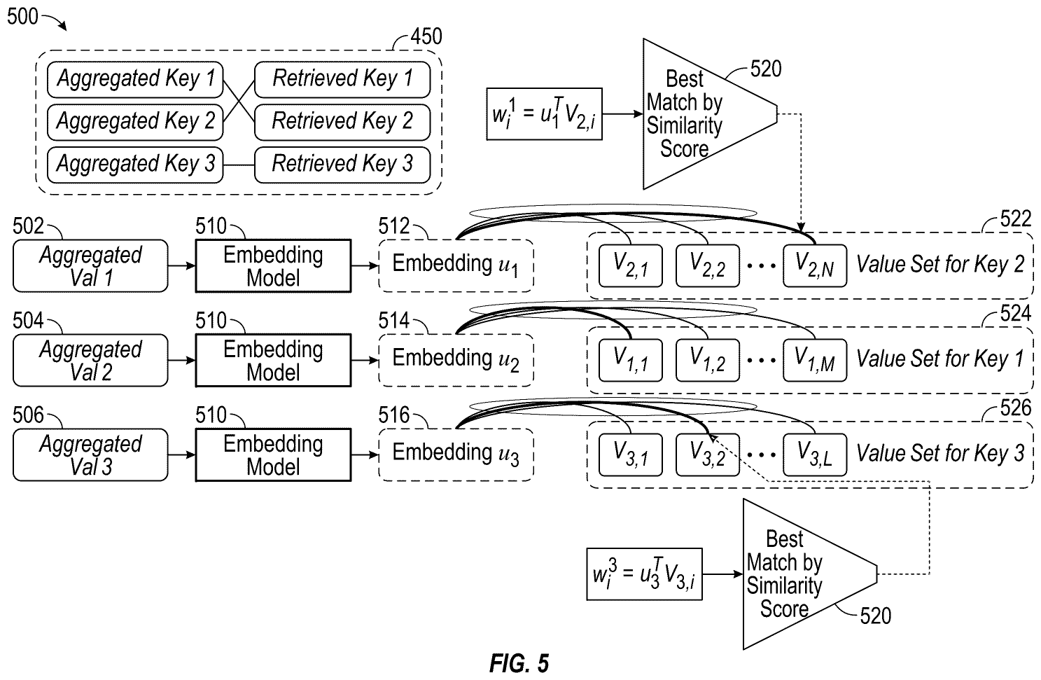

FIG. 5 illustrates an example 500 of API call matching based on value embeddings, according to aspects of the present disclosure.

As illustrated, the selected API call 450 may be associated with values 502, 504, 506 from the aggregated API call 410 and value sets 522, 524, 526 for keys in the selected API call 450. To identify proper values to use in invoking the selected API call 450, embedding representations 512, 514, 516 for the values 502, 504, 506 (amongst others, not illustrated in FIG. 5) may be generated using an embedding model 510. Values in the value sets 522, 524, 526 may be compared to the embedding representations 512, 514, 516 based on a distance (or similarity score) between an embedding and the embeddings of values for a corresponding key in the selected API call 450. Generally the distance (or similarity score) of values for a given key may be represented as the dot product of an embedding for a value from the generated API call 410 (e.g., one of the embedding representations 512, 514, 516) and an embedding of a value in the value sets for a matching key. A distance (or similarity score) between an embedding u 512, 514, 516 for a value 502, 504, 506 and a value in a value set 522, 524, 526 may be calculated according to the equation:

$${w}_{i} = {u}_{j}^{T} {v}_{k , i}$$

where i corresponds to the i^{th} value of the kth value set, and j corresponds to an index of the embedding u associated with the corresponding key in the generated API call 410.

A matching value may be selected for each key based on the similarity metric calculated between a generated API call 410 and the selected API call 450. Subsequently, the matching value can be used to invoke the selected API call 450 in order to satisfy the user input based on which the generated API call 410 was generated.

By doing so, an API call conforming to the calling conventions and key names of an API may be generated, and the generative artificial intelligence model need not be trained specifically to generate an API call based on the formatting and calling conventions of any specific API. Further, because the embeddings allow for matching based on semantic similarity, the formatting of API calls may be data type-independent.

### Example Operations for Application Programming Interface (API) Call Identification Using Generative Artificial Intelligence Models

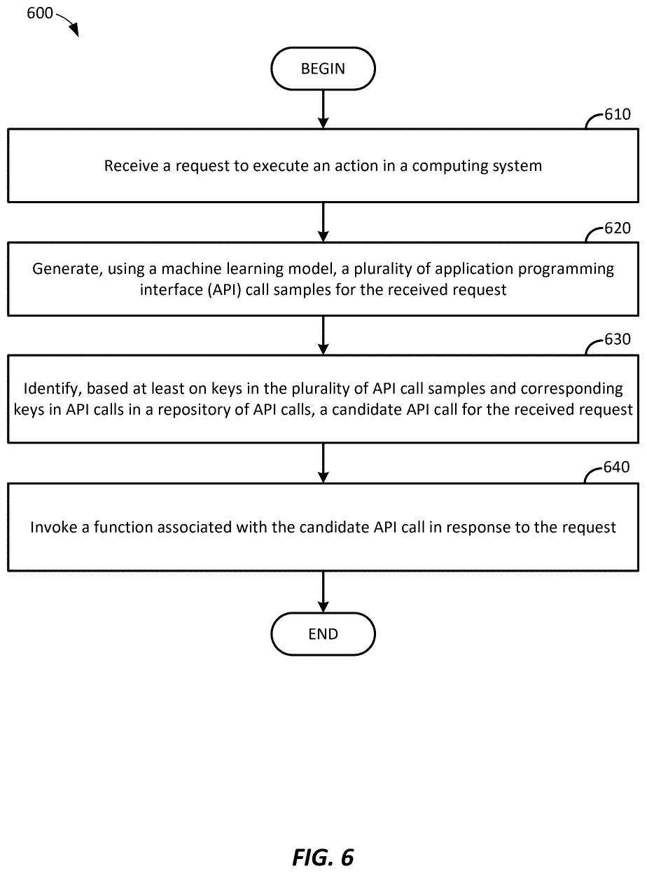

FIG. 6 illustrates example operations 600 for invoking functions in a computing system using machine learning models, according to aspects of the present disclosure.

As illustrated, the operations 600 begin at block 610, with receiving a request to execute an action in the computing system.

At block 620, the operations 600 proceed with generating, using a machine learning model, a plurality of application programming interface (API) call samples for the received request.

In some aspects, the machine learning model is configured to generate the plurality of API call samples including one or more keys that are not associated with an API call in the repository of API calls.

At block 630, the operations 600 proceed with identifying, based at least on keys in the plurality of API call samples and corresponding keys in API calls in a repository of API calls, a candidate API call for the received request.

In some aspects, identifying the candidate API call for the received request may include generating an embedding representation of keys associated with the generated plurality of API call samples. A search may be performed for a matching API call based on a vector search and the embedding representation of a key associated with each generated API call sample.

In some aspects, identifying the candidate API call for the received request may include generating key embedding representations for keys associated with the generated plurality of API call samples. A similarity score may be generated for each pair of the generated key embedding representations and retrieved key embeddings associated with the API calls in the repository of API calls. The candidate API call sample may be identified as an API call from the repository of API calls having a highest similarity score from pairs of the generated key embedding representations and the retrieved key embeddings associated with the API call from the repository of API calls.

In some aspects, identifying the candidate API call for the received request may be further based on values associated with the generated plurality of API call samples. To identifying the candidate API call for the received request, value embedding representations may be generated for values associated with the generated plurality of API call samples. A similarity score for each pair of generated value embedding representations and retrieved value embeddings associated with the API calls in the repository of API calls may be generated to allow for generated key-value pairs to be matched with real-world key-value pairs. The candidate API call may be identified as an API call from the repository of API calls having a highest similarity score from pairs of the generated value embedding representations and the retrieved value embeddings associated with the API call from the repository of API calls.

In some aspects, the identifying the candidate API call for the received request may be based on the keys and values in the plurality of API call samples and the corresponding keys and corresponding values in the API calls in the repository of API calls.

At block 640, the operations 600 proceed with invoking a function associated with the candidate API call in response to the request.

In some aspects, the operations 600 further include aggregating the generated plurality of API call samples into a plurality of aggregated call samples based on embedding values for key-value pairs in the generated plurality of API call samples. In some aspects, the plurality of aggregated call samples comprises a single representative call sample for each of a plurality of cliques generated from the embedding values for the key-value pairs in the generated plurality of API call samples. A local probabilistic model may be trained to generate clique combinations from the plurality of cliques. The generated clique combinations comprising groups of cliques may have a maximized likelihood of being generated from the plurality of API call samples.

In some aspects, the operations 600 further include sampling the clique combinations from the local probabilistic model. The sampled clique combinations may be decoded into a plurality of API call sample key-value pairs based on a reverse lookup of clique combinations to the key-value pairs.

### Example Application Programming Interface (API) Call Identification Using Generative Artificial Intelligence Models

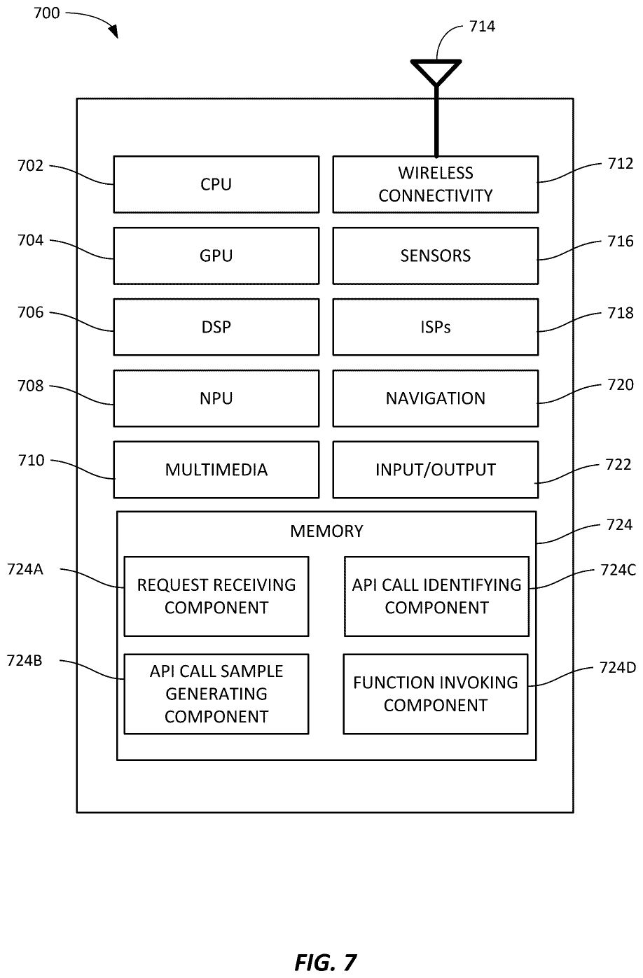

FIG. 7 depicts an example processing system 700 configured to perform various aspects of the present disclosure, including, for example, the techniques and methods described with respect to FIGS. 1-6. In some aspects, the processing system 700 may train, implement, or provide a machine learning model which uses quantized data to accelerate operations and perform machine learning model operations using less power than would be used if such operations were performed using non-quantized data. Although depicted as a single system for conceptual clarity, in at least some aspects, as discussed above, the operations described below with respect to the processing system 700 may be distributed across any number of devices.

The processing system 700 includes a central processing unit (CPU) 702, which in some examples may be a multi-core CPU. Instructions executed at the CPU 702 may be loaded, for example, from a program memory associated with the CPU 702 or may be loaded from a partition of memory 724.

The processing system 700 also includes additional processing components tailored to specific functions, such as a graphics processing unit (GPU) 704, a digital signal processor (DSP) 706, a neural processing unit (NPU) 708, a multimedia processing unit 710, and a wireless connectivity component 712.

An NPU, such as NPU 708, is generally a specialized circuit configured for implementing control and arithmetic logic for executing machine learning algorithms, such as algorithms for processing artificial neural networks (ANNs), deep neural networks (DNNs), random forests (RFs), and the like. An NPU may sometimes alternatively be referred to as a neural signal processor (NSP), tensor processing unit (TPU), neural network processor (NNP), intelligence processing unit (IPU), vision processing unit (VPU), or graph processing unit.

NPUs, such as the NPU 708, are configured to accelerate the performance of common machine learning tasks, such as image classification, machine translation, object detection, and various other predictive models. In some examples, a plurality of NPUs may be instantiated on a single chip, such as a system-on-a-chip (SoC), while in other examples the NPUs may be part of a dedicated neural-network accelerator.

NPUs may be optimized for training or inference, or in some cases configured to balance performance between both. For NPUs that are capable of performing both training and inference, the two tasks may still generally be performed independently.

NPUs designed to accelerate training are generally configured to accelerate the optimization of new models, which is a highly compute-intensive operation that involves inputting an existing dataset (often labeled or tagged), iterating over the dataset, and then adjusting model parameters, such as weights and biases, in order to improve model performance. Generally, optimizing based on a wrong prediction involves propagating back through the layers of the model and determining gradients to reduce the prediction error.

NPUs designed to accelerate inference are generally configured to operate on complete models. Such NPUs may thus be configured to input a new piece of data and rapidly process this new data through an already trained model to generate a model output (e.g., an inference).

In some implementations, the NPU 708 is a part of one or more of the CPU 702, the GPU 704, and/or the DSP 706.

In some examples, the wireless connectivity component 712 may include subcomponents, for example, for third generation (3G) connectivity, fourth generation (4G) connectivity (e.g., 4G Long-Term Evolution (LTE)), fifth generation (5G) connectivity (e.g., New Radio (NR)), Wi-Fi connectivity, Bluetooth connectivity, and other wireless transmission standards. The wireless connectivity component 712 is further coupled to one or more antennas 714.

The processing system 700 may also include one or more sensor processing units 716 associated with any manner of sensor, one or more image signal processors (ISPs) 718 associated with any manner of image sensor, and/or a navigation component 720, which may include satellite-based positioning system components (e.g., GPS or GLONASS) as well as inertial positioning system components.

The processing system 700 may also include one or more input and/or output devices 722, such as screens, touch-sensitive surfaces (including touch-sensitive displays), physical buttons, speakers, microphones, and the like.

In some examples, one or more of the processors of the processing system 700 may be based on an ARM or RISC-V instruction set.

The processing system 700 also includes the memory 724, which is representative of one or more static and/or dynamic memories, such as a dynamic random access memory, a flash-based static memory, and the like. In this example, the memory 724 includes computer-executable components, which may be executed by one or more of the aforementioned processors of the processing system 700.

In particular, in this example, the memory 724 includes request receiving component 724A, an API call sample generating component 724B, an API call identifying component 724C, and a function invoking component 724D. Though depicted as discrete components for conceptual clarity in FIG. 7, the illustrated components (and others not depicted) may be collectively or individually implemented in various aspects.

Generally, the processing system 700 and/or components thereof may be configured to perform the methods described herein.

Notably, in other aspects, aspects of the processing system 700 may be omitted, such as where the processing system 700 is a server computer or the like. For example, the multimedia processing unit 710, the wireless connectivity component 712, the sensor processing units 716, the ISPs 718, and/or the navigation component 720 may be omitted in other aspects. Further, aspects of the processing system 700 may be distributed between multiple devices.

### Example Clauses

Implementation details of various aspects of the present disclosure are described in the following numbered clauses:

Clause 1: A processor-implemented method for invoking functions in a computing system using machine learning models, comprising: receiving a request to execute an action in the computing system; generating, using a machine learning model, a plurality of application programming interface (API) call samples for the received request; identifying, based at least on keys in the plurality of API call samples and corresponding keys in API calls in a repository of API calls, a candidate API call for the received request; and invoking a function associated with the candidate API call in response to the request.

Clause 2: The method of Clause 1, wherein the machine learning model is configured to generate the plurality of API call samples including one or more keys that are not associated with an API call in the repository of API calls.

Clause 3: The method of Clause 1 or 2, further comprising aggregating the generated plurality of API call samples into a plurality of aggregated call samples based on embedding values for key-value pairs in the generated plurality of API call samples.

Clause 4: The method of Clause 3, wherein the plurality of aggregated call samples comprises a single representative call sample for each of a plurality of cliques generated from the embedding values for the key-value pairs in the generated plurality of API call samples.

Clause 5: The method of Clause 4, further comprising training a local probabilistic model to generate clique combinations from the plurality of cliques, the generated clique combinations comprising groups of cliques having a maximized likelihood of being generated from the plurality of API call samples.

Clause 6: The method of Clause 5, further comprising: sampling the clique combinations from the local probabilistic model; and decoding the sampled clique combinations into a plurality of API call sample key-value pairs based on a reverse lookup of clique combinations to the key-value pairs.

Clause 7: The method of any of Clauses 1 through 6, wherein identifying the candidate API call for the received request comprises: generating an embedding representation of keys associated with the generated plurality of API call samples; and searching for a matching API call based on a vector search and the embedding representation of a key associated with each generated API call sample.

Clause 8: The method of any of Clauses 1 through 7, wherein identifying the candidate API call for the received request comprises: generating key embedding representations for keys associated with the generated plurality of API call samples; generating a similarity score for each pair of the generated key embedding representations and retrieved key embeddings associated with the API calls in the repository of API calls; and identifying the candidate API call sample as an API call from the repository of API calls having a highest similarity score from pairs of the generated key embedding representations and the retrieved key embeddings associated with the API call from the repository of API calls.

Clause 9: The method of any of Clauses 1 through 8, wherein identifying the candidate API call for the received request is further based on values associated with the generated plurality of API call samples, and wherein identifying the candidate API call for the received request comprises: generating value embedding representations for values associated with the generated plurality of API call samples; generating a similarity score for each pair of generated value embedding representations and retrieved value embeddings associated with the API calls in the repository of API calls; and identifying the candidate API call as an API call from the repository of API calls having a highest similarity score from pairs of the generated value embedding representations and the retrieved value embeddings associated with the API call from the repository of API calls.

Clause 10: The method of any of Clauses 1 through 9, wherein the identifying comprises identifying the candidate API call based on the keys and values in the plurality of API call samples and the corresponding keys and corresponding values in the API calls in the repository of API calls.

Clause 11: A processing system comprising: a memory comprising computer-executable instructions; and one or more processors configured to execute the computer-executable instructions and cause the processing system to perform a method in accordance with any of Clauses 1 through 10.

Clause 12: A processing system comprising means for performing a method in accordance with any of Clauses 1 through 10.

Clause 13: A non-transitory computer-readable medium comprising computer-executable instructions that, when executed by one or more processors of a processing system, cause the processing system to perform a method in accordance with any of Clauses 1 through 10.

Clause 14: A computer program product embodied on a computer-readable storage medium comprising code for performing a method in accordance with any of Clauses 1 through 10.

### ADDITIONAL CONSIDERATIONS

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A processor-implemented method for invoking functions in a computing system using machine learning models, comprising:
receiving a request to execute an action in the computing system;
generating, using a machine learning model, a plurality of application programming interface (API) call samples for the received request;
identifying, based at least on keys in the plurality of API call samples and corresponding keys in API calls in a repository of API calls, a candidate API call for the received request; and
invoking a function associated with the candidate API call in response to the request.

2. The method of claim 1, wherein the machine learning model is configured to generate the plurality of API call samples including one or more keys that are not associated with an API call in the repository of API calls.

3. The method of claim 1, further comprising aggregating the generated plurality of API call samples into a plurality of aggregated call samples based on embedding values for key-value pairs in the generated plurality of API call samples.

4. The method of claim 3, wherein the plurality of aggregated call samples comprises a single representative call sample for each of a plurality of cliques generated from the embedding values for the key-value pairs in the generated plurality of API call samples.

5. The method of claim 4, further comprising training a local probabilistic model to generate clique combinations from the plurality of cliques, the generated clique combinations comprising groups of cliques having a maximized likelihood of being generated from the plurality of API call samples.

6. The method of claim 5, further comprising:
sampling the clique combinations from the local probabilistic model; and
decoding the sampled clique combinations into a plurality of API call sample key-value pairs based on a reverse lookup of clique combinations to the key-value pairs.

7. The method of claim 1, wherein identifying the candidate API call for the received request comprises:
generating an embedding representation of keys associated with the generated plurality of API call samples; and
searching for a matching API call based on a vector search and the embedding representation of a key associated with each generated API call sample.

8. The method of claim 1, wherein identifying the candidate API call for the received request comprises:
generating key embedding representations for keys associated with the generated plurality of API call samples;
generating a similarity score for each pair of the generated key embedding representations and retrieved key embeddings associated with the API calls in the repository of API calls; and
identifying the candidate API call sample as an API call from the repository of API calls having a highest similarity score from pairs of the generated key embedding representations and the retrieved key embeddings associated with the API call from the repository of API calls.

9. The method of claim 1, wherein identifying the candidate API call for the received request is further based on values associated with the generated plurality of API call samples, and wherein identifying the candidate API call for the received request comprises:
generating value embedding representations for values associated with the generated plurality of API call samples;
generating a similarity score for each pair of generated value embedding representations and retrieved value embeddings associated with the API calls in the repository of API calls; and
identifying the candidate API call as an API call from the repository of API calls having a highest similarity score from pairs of the generated value embedding representations and the retrieved value embeddings associated with the API call from the repository of API calls.

10. The method of claim 1, wherein the identifying comprises identifying the candidate API call based on the keys and values in the plurality of API call samples and the corresponding keys and corresponding values in the API calls in the repository of API calls.

11. A processing system for invoking functions in a computing system using machine learning models, comprising::
at least one memory having executable instructions stored thereon; and
one or more processors configured to execute the executable instructions in order to cause the processing system to::
receive a request to execute an action in the computing system;
generate, using a machine learning model, a plurality of application programming interface (API) call samples for the received request;
identify, based at least on keys in the plurality of API call samples and corresponding keys in API calls in a repository of API calls, a candidate API call for the received request; and
invoke a function associated with the candidate API call in response to the request.

12. The processing system of claim 11, wherein the machine learning model is configured to generate the plurality of API call samples including one or more keys that are not associated with an API call in the repository of API calls.

13. The processing system of claim 11, wherein the one or more processors are further configured to cause the processing system to aggregate the generated plurality of API call samples into a plurality of aggregated call samples based on embedding values for key-value pairs in the generated plurality of API call samples.

14. The processing system of claim 13, wherein the plurality of aggregated call samples comprises a single representative call sample for each of a plurality of cliques generated from the embedding values for the key-value pairs in the generated plurality of API call samples.

15. The processing system of claim 14, wherein the one or more processors are further configured to cause the processing system to train a local probabilistic model to generate clique combinations from the plurality of cliques, the generated clique combinations comprising groups of cliques having a maximized likelihood of being generated from the plurality of API call samples.

16. The processing system of claim 15, wherein the one or more processors are further configured to cause the processing system to:
sample the clique combinations from the local probabilistic model; and
decode the sampled clique combinations into a plurality of API call sample key-value pairs based on a reverse lookup of clique combinations to the key-value pairs.

17. The processing system of claim 11, wherein to identify the candidate API call for the received request, the one or more processors are configured to cause the processing system to:
generate an embedding representation of keys associated with the generated plurality of API call samples; and
search for a matching API call based on a vector search and the embedding representation of a key associated with each generated API call sample.

18. The processing system of claim 11, wherein to identify the candidate API call for the received request, the one or more processors are configured to cause the processing system to:
generate key embedding representations for keys associated with the generated plurality of API call samples;
generate a similarity score for each pair of the generated key embedding representations and retrieved key embeddings associated with the API calls in the repository of API calls; and
identify the candidate API call sample as an API call from the repository of API calls having a highest similarity score from pairs of the generated key embedding representations and the retrieved key embeddings associated with the API call from the repository of API calls.

19. The processing system of claim 11, wherein the candidate API call for the received request is identified further based on values associated with the generated plurality of API call samples, and wherein to identify the candidate API call for the received request, the one or more processors are configured to cause the processing system to:
generate value embedding representations for values associated with the generated plurality of API call samples;
generate a similarity score for each pair of generated value embedding representations and retrieved value embeddings associated with the API calls in the repository of API calls; and
identify the candidate API call as an API call from the repository of API calls having a highest similarity score from pairs of the generated value embedding representations and the retrieved value embeddings associated with the API call from the repository of API calls.

20. The processing system of claim 11, wherein to identify the candidate API call for the received request, the one or more processors are configured to cause the processing system to identify the candidate API call based on the keys and values in the plurality of API call samples and the corresponding keys and corresponding values in the API calls in the repository of API calls.
